(19) United States
(12) Patent Application Publication
(10) Pub. No.: US 2017/0132016 A1
(43) Pub. Date: May 11, 2017

(54) SYSTEM AND METHOD FOR ADAPTING THE USER-INTERFACE TO THE USER ATTENTION AND DRIVING CONDITIONS

(71) Applicant: PROJECT RAY LTD., Yokneam (IL)

(72) Inventors: Boaz ZILBERMAN, Ramat Hasharon (IL); Michael VAKULENKO, Zichron Yaakov (IL); Nimrod SANDLERMAN, Ramat-Gan (IL); Arik SIEGEL, Tzur Moshe (IL)

(73) Assignee: PROJECT RAY LTD., Yokneam (IL)

(21) Appl. No.: 15/102,143

(22) PCT Filed: Mar. 13, 2016
(86) PCT No.: PCT/IL2016/050273

§ 371 Date: Jun. 6, 2016

Related U.S. Application Data
(60) Provisional application No. 62/132,525, filed on Mar. 13, 2015.

(51) Int. Cl. G06F 9/44; G06F 3/16; B60K 37/06

(52) U.S. Cl. CPC G06F 9/4443; B60K 37/06; G06F 3/165; G06F 3/167; B60K 2350/352; B60K 2350/1028; B60K 2350/1056; B60K 2350/962

(57) ABSTRACT

A method, a device, and/or a computer program for adapting user interface of a mobile application to the available attention of the driver, including receiving an assessment of user attention available to operate a device and/or a software program, assessing user attention required to operate the device and/or the software program, and adapting the user-interface of the device and/or the software program according to the assessment of user available attention.

### FIELD

The method and apparatus disclosed herein are related to the field of user-interface of computing devices, and, more particularly, but not exclusively to user-interface of mobile device operated in automotive environment.

### CROSS-REFERENCE TO RELATED APPLICATIONS

This application claims priority from U.S. Provisional Patent Application Ser. No. 62/132,525 filed Mar. 13, 2015, entitled “Use of Motion Sensors on the Steering Wheel to Create Adaptive User Interface in the Car”, the disclosure of which is hereby incorporated by reference.

This patent application is related to a co-owned PCT application, the disclosure of which is hereby incorporated by reference in its entirety, which is being filed same day and is entitled “SYSTEM AND METHOD FOR ASSESSING USER ATTENTION WHILE DRIVING”.

### BACKGROUND

Mobile communication is highly intrusive and requires attention in the most uncomfortable situations. In some situations, the interruption caused by mobile communication or mobile application may be dangerous, for example, while driving a car. The user-interface of a common mobile device is uncomfortable, if not dangerous, when used while driving. There is thus a widely recognized need for, and it would be highly advantageous to have, a system and method for adapting the user-interface to the automotive environment.

### SUMMARY OF THE INVENTION

According to one exemplary embodiment there is provided a method, a device, and/or a computer program for adapting user interface, including receiving an assessment of user attention available to operate at least one of a device and a software program, assessing user attention required to operate the at least one of a device and a software program, and adapting user-interface of the at least one of a device and a software program according to the assessment of user available attention.

According to another exemplary embodiment, the method, device, and/or computer program may additionally include defining a plurality of ambient conditions, associating a set of measurable ambient values for each of the ambient conditions, measuring at least one of the ambient conditions to form a measured ambient value, and adapting the user-interface according to the assessment of user available attention and the measured ambient value.

According to still another exemplary embodiment, the method, device, and/or computer program may additionally include defining at least one driver's behavioral parameter, associating a set of measurable behavioral values for the at least one driver's behavioral parameter, measuring the at least one driver's behavioral parameter to form a measured behavioral value, and adapting the user-interface according to the assessment of user available attention and the measured behavioral value.

According to yet another exemplary embodiment, the method, device, and/or computer program may additionally include measuring user response to form response quality, and adapting the user-interface according to the response quality.

Further according to another exemplary embodiment, the method, device, and/or computer program may additionally include the step of adapting user-interface may include selecting at least one of an output device configured to interact with the user, input device configured to interact with the user, user-interface mode, and a user-interface format.

Still further according to another exemplary embodiment, the method, device, and/or computer program the user available attention may be assessed by defining a plurality of ambient conditions, associating a set of measurable ambient values for each of the ambient conditions, providing at least one rule for computing a user attention requirement value based on at least one of the measurable ambient values, measuring at least one of the ambient conditions to form a measured ambient value, and computing user attention requirement including at least one of the measured ambient values, using the at least one rule.

Yet further according to another exemplary embodiment, the method, device, and/or computer program the ambient condition may include at least one of: performance of a car, driving activity of a driver of a car, non-driving activity of a driver of a car, activity of a passenger in a car, activity of an apparatus in a car, road condition, off-road condition, roadside condition, traffic conditions, navigation, time of day, and weather.

Even further according to another exemplary embodiment, the method, device, and/or computer program may additionally include the steps of: defining at least one driver's behavioral parameter, associating a set of measurable behavioral values for the at least one driver's behavioral parameter, measuring the at least one driver's behavioral parameter to form a measured behavioral value, and providing at least one rule for computing a user attention requirement value based on at least one of the measurable ambient values and the measured behavioral value.

Additionally, according to another exemplary embodiment, the method, device, and/or computer program the driver's behavioral parameter may include history of the driver driving a car being currently driven, driving a road being currently driven, operating a steering wheel, operating accelerator pedal, operating breaking pedal, operating gearbox, driving a car in current road condition, off-road condition, roadside condition, driving a car in current traffic conditions, driving a car in current weather conditions, operating apparatus currently operated, and driving with a passenger currently in the car.

According to still another exemplary embodiment, the method, device, and/or computer program, at least one of the output device, input device, and user-interface mode may include at least one of mode selected from a group of mode including: sound, speech output, speech input, visual output, dashboard display, tactile input, touch sensitive screen, and steering-wheel control, and, additionally, the mode is selected according to at least one of: available attention, ambient condition and behavioral value.

According to yet another exemplary embodiment, the method, device, and/or computer program may at least one of the output device, input device, and user-interface format may include at least one format of a group of formats including: up-down selection, left-right selection, D-pad selection, eight-way selection, yes-no selection, numeral selection and cued selection, and additionally the format may be selected according to at least one of: available attention, ambient condition and behavioral value.

Further according to another exemplary embodiment, the method, device, and/or computer program the mode may include speech and the format may include varying rate of the speech, and/or varying volume of the speech.

Still further according to another exemplary embodiment of the method, device, and/or computer program, the step of adapting the user-interface may include delaying an output to the user, eliminating an at least one of an option and a function, and/or splitting a menu.

Additionally, according to another exemplary embodiment, the method, device, and/or computer program may include measuring effects consuming attention of a user operating at least one of a first device and a first software program, assessing attention requirement from the user by the effects, assessing for the user available attention for operating at least one of a second device and a second software program, where the at least one of a second device and a second software program includes a user-interface, modifying the user-interface according to the available attention, measuring user interaction with the at least one of second device and a second software program to form level of user response, and adapting the user-interface according to the level of user response.

According to yet another exemplary embodiment of the method, device, and/or computer program, the step of modifying the user-interface additionally includes associating at least one of the effects with a first sensory type, and the step of modifying the user-interface additionally includes using a second sensory type being different than the first sensory type.

According to still another exemplary embodiment the method, device, and/or computer program the step of assessing for the user available attention may include detecting for the user at least one diminished sensory type, and the step of modifying the user-interface may use a second sensory type different than the diminished sensory type.

Further according to another exemplary embodiment of the method, device, and/or computer program the step of adapting the user-interface additionally may adapt the user-interface to improve the level of user response with respect to a predefined level.

Yet further according to another exemplary embodiment of the method, device, and/or computer program, modifying the user-interface according to the available attention, and adapting the user-interface according to the level of user response, may additionally include selecting at least one of: an output device configured to interact with the user, an input device configured to interact with the user, a user-interface mode, and a user-interface format.

Even further according to another exemplary embodiment of the method, device, and/or computer program modifying the user-interface according to the available attention, and adapting the user-interface according to the level of user response, may additionally include at least one of: using a peripheral user-output device other than a native user-output device of the at least one of second device and a second software program, and emulation of a user entry using a peripheral user-input device other than a native user-input device of the at least one of second device and a second software program.

Additionally, according to another exemplary embodiment, the method, device, and/or computer program may assess the attention requirement from the user by the modified user-interface to form UI attention requirement, and modify the user-interface to achieve UI attention requirement below the available attention.

According to still another exemplary embodiment the method, device, and/or computer program the step of adapting the user-interface may include at least one of: delaying an output to the user, eliminating an at least one of an option and a function, splitting a menu, and reducing number of options in a menu.

According to yet another exemplary embodiment of the method, device, and/or computer program the step of modifying the user-interface may additionally include associating at least one of the effects with at least one first sensory type, and the step of modifying the user-interface additionally including at least one of: using a peripheral user-output device adapted to a second sensory type being different than the first sensory type, and emulation of a user entry using a peripheral user-input device adapted to a second sensory type being different than the first sensory type, and detecting for the user at least one diminished sensory type, and where the step of modifying the user-interface includes: using a peripheral user-output device adapted to a second sensory type being different than the first sensory type, and emulation of a user entry using a peripheral user-input device adapted to a second sensory type being different than the first sensory type.

Further according to another exemplary embodiment, the method, device, and/or computer program may include defining at least one driver's behavioral parameter, associating a set of measurable behavioral values for the at least one driver's behavioral parameter, measuring the at least one driver's behavioral parameter to form a measured behavioral value, and adapting the user-interface according to the assessment of user available attention and the measured behavioral value.

Still further according to another exemplary embodiment of the method, device, and/or computer program the user available attention may be assessed by a method including: defining a plurality of ambient conditions, associating a set of measurable ambient values for each of the ambient conditions, providing at least one rule for computing a user attention requirement value based on at least one of the measurable ambient values, measuring at least one of the ambient conditions to form a measured ambient value, and computing user attention requirement including at least one of the measured ambient values, using the at least one rule.

Yet further according to another exemplary embodiment of the method, device, and/or computer program at least one of the output device, input device, and user-interface mode includes at least one of mode selected from a group of mode including: sound, speech output, speech input, visual output, dashboard display, tactile input, touch sensitive screen, and steering-wheel control, and the mode may be selected according to at least one of: available attention, ambient condition and behavioral value.

Even further according to another exemplary embodiment of the method, device, and/or computer program at least one of the output device, input device, and user-interface format includes at least one format of a group of formats including: up-down selection, left-right selection, D-pad selection, eight-way selection, yes-no selection, numeral selection and cued selection, and the format may be selected according to at least one of: available attention, ambient condition and behavioral value.

Also, according to another exemplary embodiment the method, device, and/or computer program the mode may include speech and the format may include at least one of varying rate of the speech, and varying volume of the speech.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified illustration of an adaptive UI system;

FIG. 2 is a simplified block diagram of a computing system for processing adaptive UI software;

FIG. 3 a simplified block diagram of adaptive UI system;

FIG. 4 is a simplified block diagram of attention assessment and adaptive UI software;

FIG. 5 is a simplified flow-chart of data-collection process;

FIG. 6 is a simplified flow-chart of attention assessment process;

FIG. 7 is a simplified flow-chart of a personal data collection process;

FIG. 8 is a simplified block-diagram of UI modification software program;

FIG. 9 is a simplified flow-chart of UI modification software program; and

FIG. 10 is a simplified flow-chart of UI selection process.

### DESCRIPTION OF THE PREFERRED EMBODIMENTS

The present embodiments comprise systems and methods for adapting the user-interface (UI) of a computing system in a vehicle to the driver's available attention and/or the driving conditions. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was, described.

The drawings in this document may not be to any scale. Different Figs. may use different scales and different scales can be used even within the same drawing, for example different scales for different views of the same object or different scales for the two adjacent objects.

The purpose of the embodiments is to provide at least one system and/or method for adapting UI to driving conditions, ambient conditions, and/or driver's activity, and/or driver's attention required by such ambient conditions and/or driving conditions, and/or driver's available attention.

The term ‘car’ herein refers to any type of vehicle, and/or moving platform, and/or transportation equipment. Such vehicle may be a land vehicle including trains, construction equipment, etc., a vessel, boat, ship, marine equipment, etc., an aerial vehicle, airplane, drone, etc. It is appreciated that while embodiments below refer to a moving car or vehicle and thus to changing road conditions, manually operated stationary equipment is also contemplated, such as a crane.

The term “driver’ refers to a human operating any type of car as defined above. The term ‘passenger’ refers to any human within the car other than the driver.

The terms ‘ambience’ and ‘ambient’ as in ‘ambience-related’, ‘ambient sensor’ and ‘ambient condition’ refers to user's surrounding, and particularly to the state of the user's surroundings affecting the user and/or affected by the user. Particularly, the terms relates to the conditions outside the car and/or inside the car, and optionally and additionally, to any condition or situation affecting the car or the driver or requiring or affecting the attention of the driver of the car. In this respect the term ambience′ and/or ‘ambient’ may refer to the car itself, or any of the car's components, and/or any condition or situation inside the car, and/or any condition or situation outside the car. Ambient conditions and/or situation outside the car may include, but are not limited to, the road, off-road, roadside, etc., and/or weather.

The terms ‘computing equipment’ and/or ‘computing system’ and/or ‘computing device’ and/or ‘computational system’ and/or ‘computational device’, etc. may refer to any type or combination of devices, or computing-related units, which are capable of executing any type of software program, including, but not limited to, a processing device, a memory device, a storage device, and/or a communication device.

The term ‘mobile device’ refers to any type of computational device installed and/or mounted and/or placed in the car, which may require and/or affect the attention of the driver. A mobile device may include components of the original car, after-market devices, and portable devices. Such a mobile device may not be mechanically connected to the car, such as a mobile telephone (smartphone) in the driver's pocket. Such mobile devices may include a mobile telephone and/or smartphone, a tablet computer, a laptop computer, a PDA, a speakerphone system installed in the car, the car entertainment system (e.g., radio, CD player, etc.), a radio communication device, etc. A mobile device is typically communicatively coupled to a communication network (as further defined below) and particularly to a wireless and/or cellular communication network.

The term ‘mobile application’ or simply ‘application’ refers to any type of software and/or computer program, which can be executed by a mobile device and interact with a driver and/or a passenger using any type of user-interface. The term ‘executed’ may refer to the use, operation, processing, execution, installing, loading, etc., of any type of software program.

The term ‘network’ or ‘communication network’ refers to any type of communication medium, including but not limited to, a fixed (wire, cable) network, a wireless network, and/or a satellite network, a wide area network (WAN) fixed or wireless, including various types of cellular networks, a local area network (LAN) fixed or wireless including Wi-Fi, and a personal area network (PAN) fixes or wireless including Bluetooth and NFC, and any may number of networks and combination of networks thereof.

The term ‘server’ or ‘communication server’ or ‘network server’ refers to any type of computing machine connected to a communication network and providing computing and/or software processing services to any number of terminal devices connected to the communication network.

The term ‘ear computer’ or ‘car controller’ may refer to any type of computing device within the car that may provide information in real-time (other than the driver's mobile device such as smartphone). Such car computer of controller may include an engine management computer, a gearbox computer, etc.

The term ‘car entertainment system’ refers to any audio and/or video system installed in the car, including radio system, TV system, satellite system, speakerphone system for integrating with a mobile telephone, automotive navigation system, GPS device, reverse proximity notification system, reverse camera, dashboard camera, collision avoidance system, etc.

The term ‘ambient attention’ refers to the driver's attention directed to, or consumed by, or required by, the ambient as defined above. The term ‘mobile attention’ refers to the driver's attention directed to the mobile device and/or mobile application. The term ‘available attention’ refers to the driver's ability to direct attention to the mobile device and/or mobile application.

The purpose of the system and method described herein is to adapt the mobile attention to the available attention, or, more particularly, to adapt the UI of the mobile device and/or mobile application so that it requires driver's attention that is not greater than the available attention. In other words, the purpose of the system and method described herein is to decrease the mobile attention below the available attention.

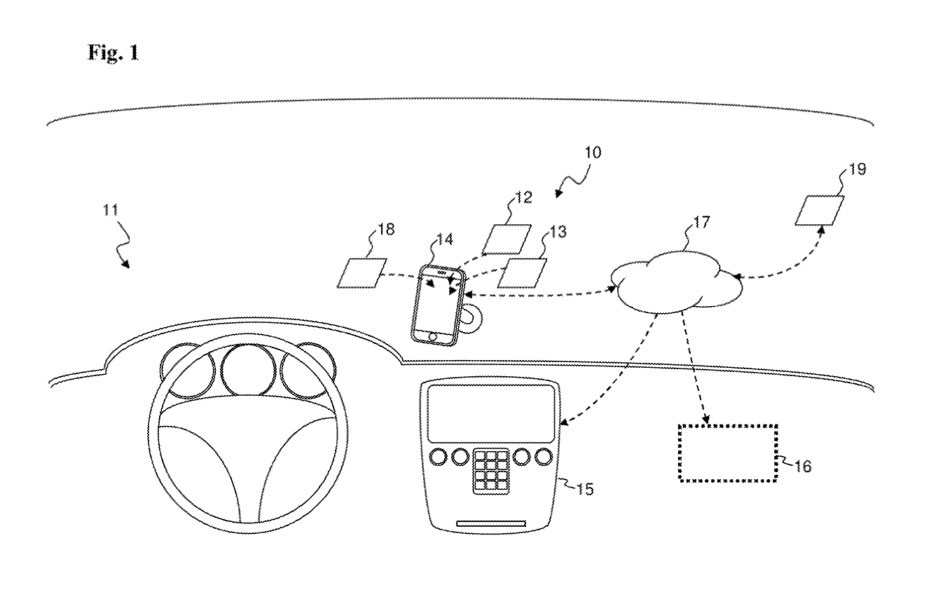

Reference is now made to FIG. 1, which is a simplified illustration of an adaptive UI system 10, according to one exemplary embodiment.

FIG. 1 shows interior of a car 11 including adaptive UI system 10, which may include a driver attention assessment system and a UI modification system.

The user-interface (UI) modification system may include UI modification software program 12 and various user-interface devices (UID). UIDs may be output devices such as speakers and displays, and input devices such as microphones, buttons, keys, switches, keypads, touch screen and/or touch sensors.

The driver attention assessment system may include an attention assessment software program 13 executed by any computing equipment in a car. Particularly, but not exclusively, UIDs may include user input devices embedded in the steering wheel, also known as steering wheel controls. Particularly, but not exclusively, UIDs 33 may include user output devices embedded in the car such as a dashboard display or the display of the car entertainment system.

UIDs may also include devices and/or software program enabling user interaction such as by generating speech (e.g., text-to-speech) or recognizing speech (e.g., speech recognition).

UI modification software program 12 and attention assessment software 13 may be executed by one or more processors, by the same processor(s), or by different processor(s). UI modification software program 12 and/or attention assessment software 13 (programs 12 and 13) may be executed, for example, by a processor of a mobile communication device such as smartphone 14, a car entertainment system and/or speakerphone system 15, a car computer 16, etc.

Programs 12 and 13 may also communicate via, for example, communication network 17, with any other computing device in the car such as smartphone 14, car entertainment system and/or speakerphone system 15, a car computer 16, etc. For example, any of programs 12 and 13 may be executed by smartphone 14, and communicate with car entertainment system and/or speakerphone system 15, and with car computer 16.

Programs 12 and 13 may also communicate via, for example, communication network 17, with any other computing device outside the car, including road sensors, traffic communication processors, processor operating in near-by cars, etc.

Mobile communication device (smartphone) 14 may also execute any number of mobile applications 18. UI modification software program 12 and/or attention assessment software 13 may also communicate with any such mobile applications 18, either executed by the same smartphone 14 and/or by any other computational device in the car. For example, programs 12 and/or 13 may communicate with a navigation software executed by smartphone 14, and/or with a navigation device installed in the car, and/or with a navigation software executed by a smartphone of a passenger in the car.

Programs 12 and/or 13 may also communicate with one or more information services 19, typically external to the car. Programs 12 and/or 13 may communicate with such services, for example, via communication network 17. Such information services may be, for example, weather information service.

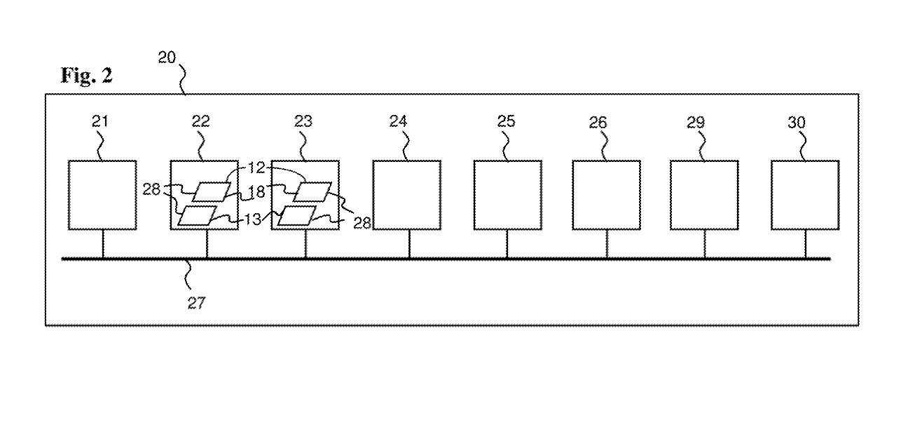

Reference is now made to FIG. 2, which is a simplified block diagram of a computing system 20, according to one exemplary embodiment. As an option, the block diagram of FIG. 2 may be viewed in the context of the details of the previous Figures. Of course, however, the block diagram of FIG. 2 may be viewed in the context of any desired environment. Further, the aforementioned definitions may equally apply to the description below.

Computing system 20 is a block diagram of a computing device used for executing UI modification software program 12, and/or attention assessment software 13, and/or mobile application 18. Computing system 20 may execute any one of these software programs, all of these software programs, or any combination of these software programs.

As shown in FIG. 2, computing system 20 may include at least one processor unit 21, one or more memory units 22 (e.g., random access memory (RAM), a non-volatile memory such as a Flash memory, etc.), one or more storage units 23 (e.g. including a hard disk drive and/or a removable storage drive, representing a floppy disk drive, a magnetic tape drive, a compact disk drive, a flash memory device, etc.).

Computing system 20 may also include one or more communication units 24, one or more graphic processors 25 and displays 26, and one or more communication buses 27 connecting the above units.

Computing system 20 may also include one or more computer programs 28, or computer control logic algorithms, which may be stored in any of the memory units 22 and/or storage units 23. Such computer programs, when executed, enable computing system 20 to perform various functions (e.g. as set forth in the context of FIG. 1, etc.). Memory units 22 and/or storage units 23 and/or any other storage are possible examples of tangible computer-readable media. Particularly, computer programs 28 may include UI modification software program 12, attention assessment software 13, and/or mobile application 18 or parts, or combinations, thereof.

Computing system 20 may also include, or operate, user-interface devices 29 such as UID described above, and/or user-interface device drivers.

Computing system 20 may also include, or operate, one or more sensors 30 and/or sensor drivers. Sensors 30 are typically configured to sense ambient conditions, situations, and/or events.

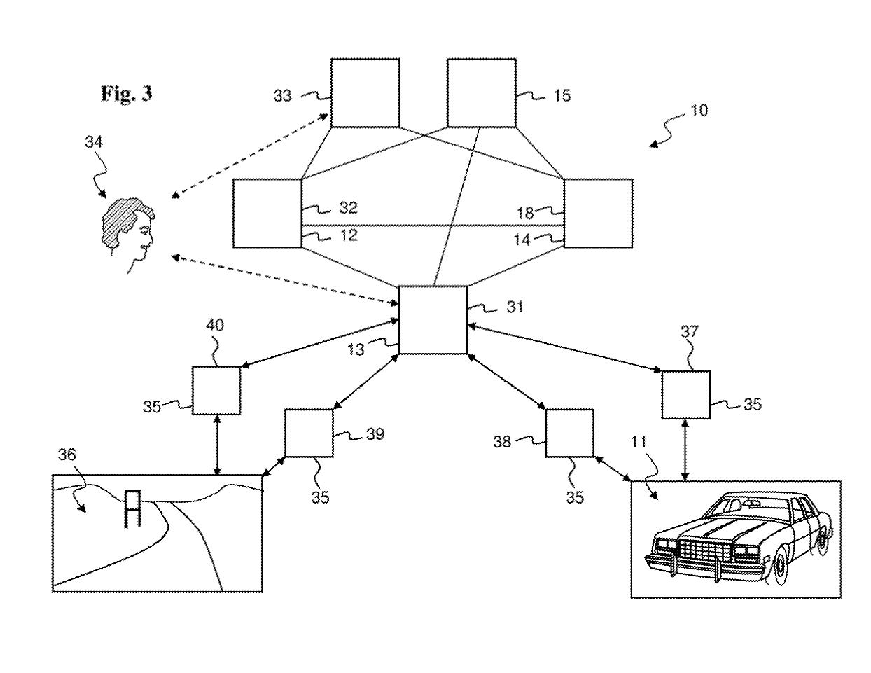

Reference is now made to FIG. 3, which is a simplified block diagram of adaptive UI system 10, according to one exemplary embodiment. As an option, the adaptive UI system 10 of FIG. 3 may be viewed in the context of the details of the previous Figures. Of course, however, the adaptive UI system 10 of FIG. 3 may be viewed in the context of any desired environment. Further, the aforementioned definitions may equally apply to the description below.

As shown in FIG. 3, adaptive UI system 10 may include driver attention assessment system 31 communicatively coupled with mobile device (e.g., smartphone) 14 and with UI modification system 32, which may also be communicatively coupled with mobile device (e.g., smartphone) 14.

Mobile device 14 may also be communicatively coupled with the car entertainment system and/or speakerphone system 15, and with driver attention assessment system 31. UI modification system 32 and/or mobile device 14 may be communicatively coupled with various user interface devices (UID) 33.

It is appreciated that for the purpose of this discussion the terms UI modification system 32 and UI modification software program 12 are interchangeable, the terms driver attention assessment system 31 and attention assessment software program 13 are interchangeable, and the terms mobile device (smartphone) 14 and mobile application 18 are interchangeable. Therefore, UI modification software program 12 is communicatively coupled with mobile application 18 and with attention assessment software program 13. And attention assessment software program 13 and mobile application 18 may also be communicatively coupled. Similarly, UI modification software program 12 and/or mobile application 18 may be communicatively coupled with various user interface devices (UID) 33.

It is appreciated that adaptive UI system 10, as a whole, interacts with driver 34, to assess the driver's attention as required by ambient conditions, to assess the driver's attention that may be available for interacting with the mobile application 18, and to adapt to user-interface of the mobile application 18 to the available attention of the driver.

UI modification system 32, driver attention assessment system 31 and mobile application 18 may be connected in various manners and technologies. As shown in FIG. 3, UI modification system 32, driver attention assessment system 31 and mobile application 18 may be connected directly by cables, however, any such connection may be replaced by any type of wireless connection. Alternatively, UI modification system 32, driver attention assessment system 31 and mobile application 18 may be connected may be connected over a bus, via a hub, in a daisy-chain configurations or in any other method, using any type of cable and/or wireless technology.

Driver attention assessment system 31 may also be communicatively coupled with various monitoring modules 35, and optionally also with the car speakerphone system or entertainment system 15.

The term ‘module’ may refer to a hardware module or device, or to a software module or process, typically executed by a corresponding hardware module or device. It is appreciated that any number of software module may be executed by any number of hardware module, such that one hardware module may execute more than one software modules, and/or that one software module may be executed by more than one hardware modules.

Monitoring modules 35 may include car monitoring modules that monitors the car's performance as well as the driver's activities operating the car, and ambient monitoring modules that monitor the ambient 36 outside and/or inside the car 11, and/or the surrounding of the driver, as well as the driver activities other than operating the car and passengers' activities.

Car monitoring modules may be embedded in the car 11 such as car computer or controller 37, or one or more car sensing modules 38 embedded in a mobile device such as the mobile device executing attention assessment software 13 (e.g., a smartphone). For example, a microphone, a camera, a GPS module, an accelerometer, an electronic compass, etc., typically embedded in a mobile telephone, typically operated by a respective software module, may serve as a car monitoring module. Additionally, car sensing modules embedded in a mobile device such as the mobile device executing attention assessment software may communicate with sensors mounted in the car.

Ambient monitoring modules may include or more ambient sensing modules 39 embedded in a mobile device such as the mobile device executing attention assessment software 13 (e.g., a smartphone). For example, a microphone, a camera a GPS module, an accelerometer, an electronic compass, etc., typically embedded in a mobile telephone, typically operated by a respective software module, may serve as an ambient monitoring module.

Ambient monitoring module may also be an ambient sensing mobile application 40, such as a browser, accessing one or more external services, such as a weather reporting website, and/or a mapping software (e.g., a geo-information system or service).

Ambient monitoring modules may also be, or communicate with, other applications operating in the car, such as a mapping software, and/or a navigation software, operating the mobile device executing attention assessment software, or executed by another device in the car.

It is appreciated that external information sources such as weather reporting website, mapping service, navigation software, etc., may provide forward-looking information. Such forward-looking information may enable attention assessment software to anticipate future events potentially affecting, and/or requiring, the driver's attention. A weather service may inform the attention assessment software of a rain, snow, or ice ahead of the car. A mapping service may inform the attention assessment software of a junction, curve, bumps, etc., ahead of the car. Navigation software may provide the attention assessment software estimated time of arrival at any localized situation ahead of the car as listed above. Additionally, navigation software may provide the attention assessment software with the car planned route and anticipated driver's actions such as car turns. Therefore, ambient monitoring modules such as ambient sensing mobile application may enable attention assessment software to predict attention requirements, and/or to assess future attention requirements. Such future attention requirements may be provided as a sequence of time-related assessments, or a time-related function.

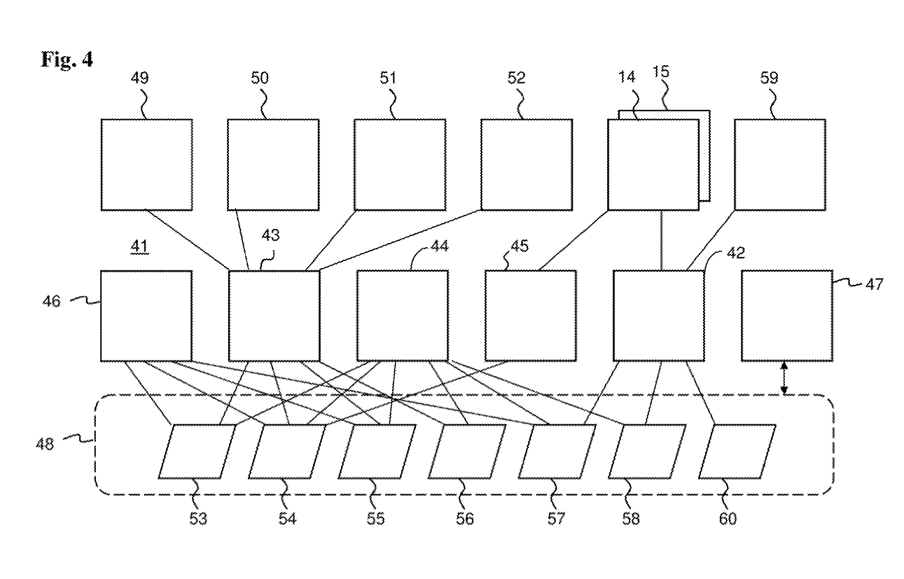

Reference is now made to FIG. 4, which is a simplified block diagram of adaptive UI software 41, according to one exemplary embodiment. As an option, the block diagram of FIG. 4 may be viewed in the context of the details of the previous Figures. Of course, however, the block diagram of FIG. 4 may be viewed in the context of any desired environment. Further, the aforementioned definitions may equally apply to the description below.

As shown in FIG. 4, adaptive UI software 41_may include attention assessment software 13 and user-interface modification module 42. Attention assessment software 13 may include a data collection module 43, an attention assessment module 44, a mobile monitoring module 45, an optional personalization module 46, an administration module 47, and database 48.

Data collection module 43 may be communicatively coupled to one or more interfacing modules such as car interface module 49, car sensing interface module 50, ambient sensing interface module 51 and ambient data collection module 52.

Car interface module 49 may be communicatively coupled, for example, to car computer or controller 37 of FIG. 3. Car sensing interface module 50 may be communicatively coupled, for example, to car sensing modules 38 of FIG. 3. Ambient sensing interface module 51 may be communicatively coupled, for example, to ambient sensing modules 39 of FIG. 3. Ambient data collection module 52 may be communicatively coupled, for example, to ambient sensing mobile application 40 of FIG. 3.

Data collection module 43 collects data received from the interfacing modules into database 48, and particularly to ambient data 53, car data 54, and personal data 55. Data collection module 43 may collect data according to data collection parameters and/or data collection rules 56.

Ambient data 53 may include current and past (historical) information about the ambient, or surroundings of the car and driver such as:

The road, including road type and quality.

Road surrounding and field of view.

Junction, curve, sign, and similar attention consuming characteristics of the road ahead of the car.

Traffic conditions, including traffic load and average speed.

Weather conditions such as temperature, precipitation rate, type of precipitation, etc.

Time of day and road lighting conditions.

Traffic conditions may include actual conditions experienced at the time of operation, or estimated traffic based on the analysis of past traffic patterns at a specific time, day of week, time of year and location.

Weather conditions may include the driver's position and orientation with respect to the sun, as well as the sun elevation, at a specific time of day (e.g. assessing direct sunlight affecting visibility when the sun is low in front of the driver). Sunlight direction (horizontally and/or vertically) may also affect the visibility of any particular display, such as smartphone display and/or dashboard display, thus also affecting the driver's attention requirements.

Car data 54 may include current and past (historical) information about the car, such as speed, acceleration, change of direction, noise level (including music, speech, and conversation), steering wheel position, gear position, breaking pedal status, status of the car's lights, turn signals (including internal sound system), status of the windshield wiper system, status of the entertainment system (including status of the speakerphone system), etc.

Personal data 55 may include current and past (historical) information about the driver, such as the driver's age, gender, driving style, accident and near accident history, vision health, auditory health, general health conditions, the driver's history (acquaintance) with the particular road, with the particular road type, speed, weather conditions, etc.

Any type of data collected by the data collection module 43 may be subject to one or more data collection parameters and/or rule 56. Data collection module 43 may use such data collection parameters or and/rules 56 to determine which data (e.g., ambient, car, and/or personal) should be collected, when to collect such data, how often to collect the data, etc.

Some of the collected data, and particularly ambient data, is forward-looking. For example, anticipating road conditions and/or traffic conditions ahead of the car. Such forward-looking data is collected for a particular distance or time-of-travel ahead of the car. Collection parameters and/or data collection rules 56 may indicate the required distance or time-of-travel. The data collection module 43 uses such data collection rules and/or parameters to determine the forward-looking data that should be collected. Such data collection rules and/or parameters may include ambient-related parameters such as road conditions, weather conditions, time of day, etc., car-related parameters such as speed, and personal parameters such as the driver's acquaintance with the road.

Collection parameters and/or data collection rules 56 may also apply to the analysis of some measurements taken by various sensors such as microphones, cameras, accelerometers, GPS systems, etc. For example, data collection rules 56 may compute a correlation between steering wheel position and change of direction to assess road condition.

Attention assessment module 44 may use collected data such as ambient data 53, car data 54, and personal data 55 as input data, and may output attention assessment data 57. Attention assessment module 44 may compute attention assessment data 57 based on attention assessment rules 58.

Data collection rules may include temporal parameters such as sampling time (e.g., for the next sampling), sampling rate, sampling accuracy, notification threshold, etc. For example, sampling accuracy and/or notification threshold may determine the value of a change of a particular sampled and/or measured value for which a notification should be provided to an attention assessment module or the like.

For example, a first data collection rule measuring a first ambient condition (or car condition, etc.) may indicate that, upon a particular value sampled or measured for that first ambient condition, a particular change of one or more parameters, such as temporal parameters, of one or more other data collection rules.

Attention assessment rules may also include temporal parameters, such as the rate of calculating attention requirements, and/or the period for which attention requirements are calculated. Such period for which attention requirements are calculated may include the past as well as the future. For example, such period may include driver's relaxation period in which, for example, an attention-related status, such as stress, may decay, following removal or decrease of the associated cause.

Attention assessment rules may therefore also affect data collection rules, and particularly temporal parameters of data collection rules. For example, an attention assessment rule may determine that if the driver attention is greater than a predefined threshold one or more data collection rules should be executed more frequently, or report (notify) for a smaller change of the measured value, etc.

For example, an attention assessment rule may determine that an external source such as weather information service, road traffic conditions, and/or navigation software, should be sampled at a higher rate, or for a smaller range or period, or reduce the period for which attention requirements are calculated, etc. For example, an attention assessment rule may indicate that the navigation software should be sampled faster and for a shorter future (forward-looking) period.

User-interface modification module 42 may be connected to the user-interface software of any number of mobile applications 59, and to any number of mobile devices (e.g., smartphone 14 of FIG. 1) and/or entertainment systems and/or speakerphone systems (e.g., element 15 of FIG. 1). Using UI modification rules 60, attention assessment data 57, User-interface modification module 42 may modify the user-interface of mobile application 18 to adapt to the changing user attention requirements.

For example, user-interface modification module 42 may modify the user-interface of mobile application 18 in one or more of the following manners:

Changing the size of visible controls such as icons and/or keycaps on a display.

Changing the font size of displayed text, controls, etc.

Changing position of at least some of the controls, such as controls displayed on a touch-sensitive screen. Adding and removing controls and other UI elements from the display. Dividing controls normally presented in a single screen into two or more screens, etc. Replacing text over a control with an icon or a number or a particular color. Ordering the controls in one line (e.g. a vertical line) in a particular order, etc.

Replacing graphical interface with speech interface and vise-versa.

Replacing touch input with external controllers, such as steering wheel controls.

Applying variable speed to speech output, for example, by providing slower speech rate when the driver's available attention decreases.

Blocking, stopping and/or eliminating the operation of particular functions of the mobile application, or the offering of such functions to the driver.

Variable setting of timers in the user interface, such a timer determining a default selection. For example, increasing the timer value when the driver's available attention decreases.

Mobile monitoring module 45 may interface with the mobile device (smartphone), and particularly with a mobile application. Mobile interface module 45 may identify the particular mobile application currently executing in the mobile device (smartphone). Mobile monitoring module 45 may collect data referring to the operation of such mobile applications affecting the driver's attention.

Personalization module 46 may compute personal data 55 by correlating ambient data 53 and/or car data 54 with attention assessment data 57, therefore analyzing the sensitivity of a particular data to particular events such as ambient-related, and/or car-related events.

Administration module 47 enables a user to define a plurality of ambient conditions, for example, by introducing and/or modifying or associating one or more measurable ambient values with each of the ambient conditions, and by defining at least one rule for computing a user attention requirement value based on one or more measurable ambient values.

It is appreciated that a temporal parameter may include a time period and that the time period may include a future time and/or an expected event. The expected event may be associated with an ambient condition, or with the car, or with an application executed by a mobile device, etc. Such expected event may affect the attention of the driver. For example, such expected event may be derived from a navigation system or software anticipating a driver's action or instructing a driver's action. For example, the expected event may by an instruction to the driver to make a turn.

It is appreciated that a modified measuring rule may invoke measuring one or more other ambient conditions, for example by invoking a measurement rule, for example by modifying a parameter of the measurement rule. It is appreciated that a modified measuring rule may also invoke computing attention assessment, for example by invoking an attention analysis rule. For example by modifying a parameter of an attention analysis rule. For example by modifying a temporal parameter.

It is appreciated that the attention assessment software, may also perform such actions where the measuring of an ambient conditions, and/or the computing of user attention requirement, may modify the measuring rule. Such modification may change a temporal sampling parameter and/or a temporal analysis parameter. Such temporal sampling parameter and/or temporal analysis parameter may include a future time-period, which may include a driver's relaxation period. Such rule modification may include modifying the relaxation period.

Reference is now made to FIG. 5, which is a simplified flow-chart of data-collection process 61, according to one exemplary embodiment.

As an option, the flow-chart of data-collection process 61 of FIG. 5 may be viewed in the context of the details of the previous Figures. Of course, however, the flow-chart of data-collection process 61 of FIG. 5 may be viewed in the context of any desired environment. Further, the aforementioned definitions may equally apply to the description below. For example, data-collection process 61 may be executed by data collection module 43 of FIG. 4.

As shown in FIG. 5, data-collection process 61 may start with step 62 by receiving a particular data from any one of a plurality of data sources such as car data or ambient data that pay be provided by any of car computer or controller 37, car sensing modules 38, ambient sensing modules 39, and/or sensing mobile application 40.

Data-collection process 61 may proceed to step 63 to store the collected data in database 48, and particularly in the relevant database such as ambient data 53 and/or car data 54.

Data-collection process 61 may then proceed to step 64 to load from database 48 (e.g., a rule that applies to the received data). Data-collection process 61 may then proceed to step 65 to interrogate one or more data sources according to the particular rule loaded in step 64. Data-collection process 61 may repeat steps 64 and 65 until all the relevant rules are processed (step 66).

Based on a data collection rule, data-collection process 61 may proceed to step 67 to notify attention assessment module 44 of FIG. 4 that the collected data justifies and/or requires processing attention assessment.

Data-collection process 61 may then modify collection parameters (step 68) if needed, for the same rule or for any other data collection rule. Particularly, step 68 may select a temporal sampling parameter indicating the sampling time, or sampling period, or sampling frequency, etc. Such temporal sampling parameter may include future time and/or expected events. It is appreciated that expected events may be associated, or derived from, or created by, a mobile device or a mobile application, from example, a navigation system indicating a future turn.

Data-collection process 61 may then wait (step 69) for more data, either data which communication is initiated by the sending side (e.g., car computer), and/or scheduled measurements.

In step 65, data-collection process 61 may use the rule loaded in step 64 to execute and/or to schedule the execution of any other measurement and/or query of any type of data (e.g., ambient data) from any data source such as car data or ambient data that pay be provided by any of car computer or controller 37, car sensing modules 38, ambient sensing modules 39, and/or sensing mobile application 40.

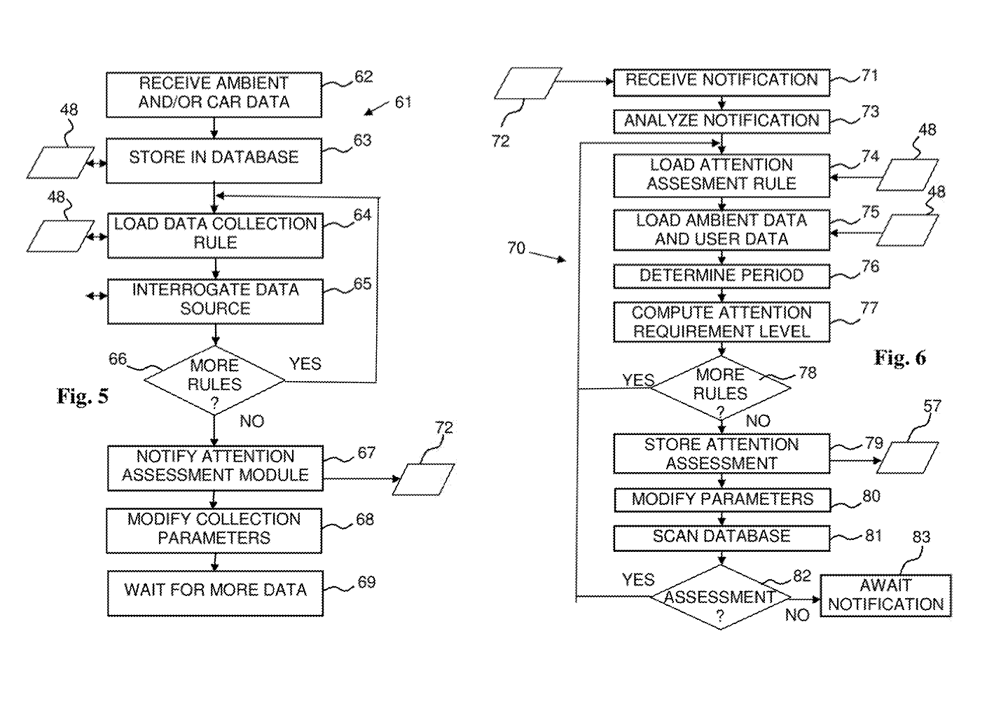

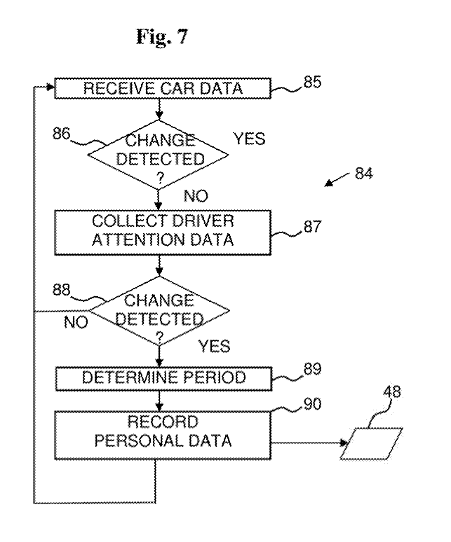

Reference is now made to FIG. 6, which is a simplified flow-chart of attention assessment process 70, according to one exemplary embodiment.

As an option, the flow-chart of attention assessment process 70 of FIG. 6 may be viewed in the context of the details of the previous Figures. Of course, however, the flow-chart of attention assessment process 70 of FIG. 6 may be viewed in the context of any desired environment. Further, the aforementioned definitions may equally apply to the description below. For example, flow-chart of attention assessment process 70 may be executed by attention assessment module 44 of FIG. 4.

As shown in FIG. 6, attention assessment process 70 may start with step 71, for example when an assessment notification 72 is received from data-collection process 61. Attention assessment process 70 may then proceed to step 73 to analyze the reason for the notification, such as a change in ambient or car data that justifies and/or requires attention assessment and/or update. Such reason typically results from a change of one or more types of ambient or car data surpassing a particular predetermined threshold.

However, some analysis may be more sophisticated. For example, the analysis module may analyze the sound picked up by a microphone in the car, such as the microphone of smartphone 14, to detect and/or characterize particular sounds.

For example, to detect the sound associated with the turning indicator light (also known as ‘direction indicators’) to determine the driver's intention to turn before the driver rotates the steering wheel and/or before the car turns. For example, the analysis module can detect human voices in the car to identify the passengers, and thus to characterize the attention load on the driver. For example, the analysis module can detect a row, a baby crying, etc. For example, the analysis module can detect an outside noise such as the siren of a first responder car (e.g., police patrol car, ambulance, fire brigade unit, etc.)

Attention assessment process 70 may then proceed to step 74 to load an attention assessment rule that is relevant to the notification reason (e.g., according to the particular one or more ambient or car data surpassing the threshold).

Attention assessment process 70 may then proceed to step 75 to load other ambient data, and/or car data, and/or personal data, as required by the particular attention assessment rule loaded in step 74.

Attention assessment process 70 may then proceed to step 76 to determine an assessment period. The assessment period refers to the time period for which collected data (e.g., ambient data, car data, user data, etc.) should be considered. This period may include past (history) data and/or future (anticipated) data. Such future data may be collected from internal and/or external sources, including weather information sources, traffic condition sources, a navigation system, etc. In step 76 attention assessment process 70 the scope and/or time-frame and/or period for which the rule, or a particular type of measurements should be calculated. Such time period may also include the relaxation period for the particular driver, for which a particular level or type of attention may persist, or decay. Assessment period as determined in step 76 may be based on a temporal sampling parameter of the relevant assessment rule.

Attention assessment process 70 may then proceed to step 77, and, using the loaded attention assessment rule, compute an attention requirement level. When all relevant attention assessment rules are processed (step 78), and Attention assessment process 70 may then proceed to step 79 to store the updated attention assessment in attention assessment data 57 of FIG. 4.

Attention assessment process 70 may then proceed to step 80 to modify any other rules, including attention assessment rules and/or data collection rules. Such modification may be performed by modifying one or more parameters of such rules, for example by modifying temporal parameters, for example by modifying a relevant time period.

Attention assessment process 70 may then proceed to step 81 to scan the ambient or car data according to further attention assessment rules to detect situations requiring further attention assessment, and, if no such situation is detected (step 82), to wait (step 83) for the next notification 72 from data-collection process 61.

It is appreciated that attention assessment, such as performed in step 77, for example as determined by a particular attention assessment rule, may associate the particular attention requirement with one or more sensory faculties or modalities. For example, attention assessment process may determine that a particular sensory faculty of the driver is loaded to a particular level. For example, the visual faculty, and/or the auditory faculty, and/or the manual faculty. In other words, attention assessment process may associate different levels of attention requirement with each sensory faculty of the driver.

It is appreciated that driver attention assessment system 31, and particularly software programs 61 and 70 may assess the attention load, or attention requirement as applicable to a driver of a car, by performing the following actions:

Enable a user to define one or more ambient conditions. The term ambient condition here may include condition or performance associated with the car, condition or situation external to the car such as the road and the environment, and condition or situation associated with the driver (other than driving the car) including historical and statistical data.

Enable a user to define and/or associate at least one measurable ambient value for each of the ambient conditions. Typically the user may define a set of measurable ambient value associated with respective levels of the measured ambient condition.

Enable a user to define and/or provide at least one attention assessment rule for computing a user attention requirement value based on at least one of the measurable ambient values. Such rule may be, for example, a formula in which the measured ambient condition is a parameter.

Measure at least one of the ambient conditions to form a measured ambient value.

Compute the user attention required by any one of the measured ambient conditions or any combination of ambient conditions using at least one of the attention assessment rules and respective measured ambient values.

Reference is now made to FIG. 7, which is a simplified flow-chart of a personal data collection process 84, according to one exemplary embodiment.

As an option, the flow-chart of personal data collection process 84 of FIG. 7 may be viewed in the context of the details of the previous Figures. Of course, however, the flow-chart of FIG. 7 may be viewed in the context of any desired environment. Further, the aforementioned definitions may equally apply to the description below.

As described above, attention assessment process 70 compute the attention load and/or requirement on the driver according to the collected ambient data and car data, and according to personal data collected for the particular data. The personal data includes, but is not limited to, the history of the driver operating the particular car, or a similar car, in the same, or similar ambient conditions. Such ambient conditions may be the particular road, or road type, the current traffic conditions, weather conditions and/or time-of-day, etc. Personal data collection process 84 collects such personal data.

As shown in FIG. 7, Personal data collection process 84 may start with step 85 by receiving one or more measurements of one or more ambient conditions or car condition and/or performance.

Personal data collection process 84 may then check (step 86) if the received measurement value indicates a change of the measured condition, for example by comparing the received value with a predetermined threshold, or by comparing the difference between the received value and a running average (for example, and average of the measurement values over a predetermined period) with a predetermined threshold.

Personal data collection process 84 may then proceed to step 87 to collect driver attention data.

Personal data collection process 84 may then check (step 88) if the received driver attention data has changed, for example by comparing the received value with a predetermined threshold, or by comparing the difference between the received value and a running average (for example, and average of the measurement values over a predetermined period) with a predetermined threshold.

If such change is detected the personal data collection process 84 may then proceed to step 89 to determine a period for which the particular data, or change of data, or condition, is valid, or requires recalculation or reassessment. For example, the period may determine the rate of relaxation of a particular condition following a particular event causing the condition.

Personal data collection process 84 may then proceed to step 90 to store the event in database 48 and/or in personal data 55, including the driver attention data, the car data and the ambient data at the particular time of record.

The driver's attention can be measured as a value within a range, for example, a number between 1 and 100. Attention assessment value of 65 may mean that the available attention is 35 or less, as an upper boundary may be set, for example, on a personal level. The assessed available attention may then be used to control the attention requirement by, for example, the mobile application.

Alternatively, or additionally, the driver's attention can be measured as a set of values, where each value indicating a different aspect of attention (attention faculty). For example, the attention requirements may be divided into visual attention, audible attention, haptic attention, cognitive attention, attention associated with orientation, etc.

Additionally, and optionally, a measure of attention sensitivity may be set, for example, on a personal level. Attention sensitivity may take the form of a quantum change of the attention assessment value. Attention sensitivity of less sensitive drivers may have a change value of 1 while more sensitive drivers may have a higher change value, such as 10. Therefore, when the attention assessment value for a less sensitive driver is, for example, increased, it can be increased by multiples of 1, while the increase for the more sensitive driver will be in multiples of 10.

Additionally, and optionally, a measure of attention relaxation period may be set, for example, on a personal level. Therefore, when the attention assessment value for a less sensitive driver is, for example, decreased, it can be decreased faster than for the more sensitive driver.

The computing of the attention assessment value may use a formula including variables for the measured ambient data and car data, and personal parameters such as the change quantum, sensitivity, relaxation period, etc. For example, whenever s measured ambient data and car data is change, and/or periodically, the attention assessment engine (e.g., step 77 of FIG. 6) recalculates the formula to provide an updated attention assessment value.

For example, attention assessment process 70 of FIG. 6 may use a single formula for computing the attention assessment value, or may have a plurality of such formulas. For example, there may be a formula for each attention faculty. Therefore, for example, traffic conditions may have a different effect on visual and audible faculties.

Additionally, and optionally, attention assessment process 70 of FIG. 6, and particularly the attention assessment engine (e.g., step 77) may use a measure of cross-correlation between such formulas and/or attention faculties. For example, a cross-correlation value may be set for the upper limit value for each attention faculty. Therefore, for example, for a particular driver, if only the visual attention is loaded by 60 (of 100) the available attention is 40. However, if the audible and haptic attention faculties are also loaded, for example by 20 (of 100), then the upper limit of the visual attention faculty is reduced, for example, to 80. Thus the available visual attention is reduced to 20 (80 minus 60).

More information regarding possible processes and/or embodiments for assessing the driver's attention may be found in U.S. Provisional Patent Application Ser. No. 62/132,525 filed Mar. 13, 2015, entitled “Use of Motion Sensors on the Steering Wheel to Create Adaptive User Interface in the Car”, which is incorporated herein by reference in their entirety.

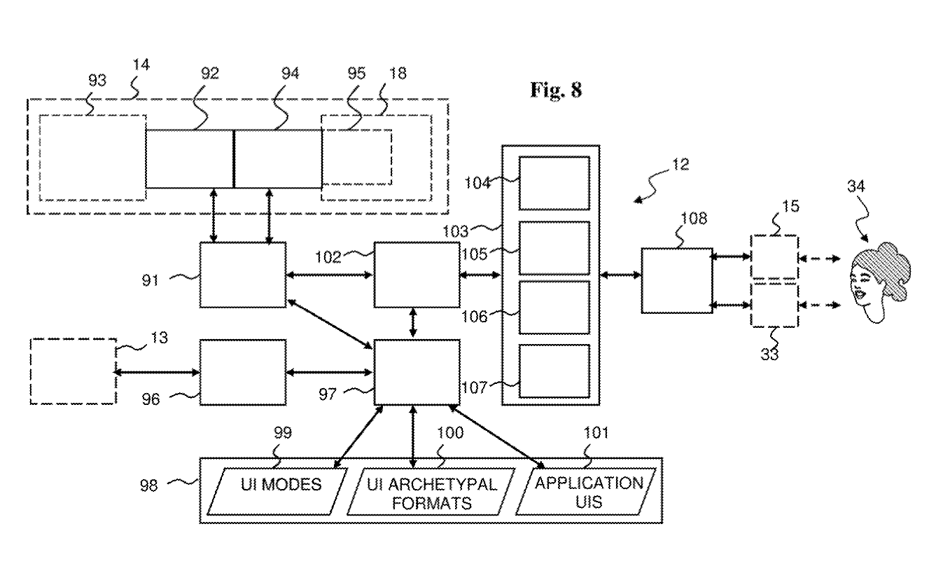

Reference is now made to FIG. 8, which is a simplified block-diagram of UI modification software program 12, according to one exemplary embodiment.

As an option, the block-diagram of UI modification software program 12 of FIG. 8 may be viewed in the context of the details of the previous Figures. Of course, however, the block-diagram of UI modification software program 12 of FIG. 8 may be viewed in the context of any desired environment. Further, the aforementioned definitions may equally apply to the description below.

As shown in FIG. 8, UI modification software program 12 may include the following modules:

A mobile interface module 91 typically configured to interface with mobile device 14. Particularly, mobile interface module 91 may communicate with one or more modules installed in the mobile device 14. One such module may be EFUI OS SDK 92.

Attention-adaptive user-interface operating-system software-development kit 92 (OS-SDK 92 for short) is a module of the adaptive UI system 10 that is installed in the mobile device 14, operating as a part of the mobile device 14 operating system 93. Particularly, OS-SDK 92 may modify the way the operating system of the mobile device 14, or a software application executed by the mobile device 14, operates the user-interface modules of the mobile device 14. Such user-interface modules may be a touch-screen, other physical and/or electrical keys and buttons, a speaker, a microphone, external UI devices communicatively coupled, for example, by Bluetooth, etc.

The term ‘attention-adaptive user-interface’ (AAUI) refers to any method and/or mechanism and/or device that may automatically adapt a user-interface of a particular device or software program (application) according to changing requirements. Particularly, the AAUI may adapt to changes in the user's attention available for the particular device or software program (application). A special case is when the AAUI completely or at least substantially reduces the need of the user to look at the device, or at the software program (application) UI. In such case the AAUI may be referred to as eye-free user-interface (EFUI).

Another module with which mobile interface module 91 may communicate may be APP-SDK 94. Attention-adaptive user-interface mobile-application software-development kit 94 (APP-SDK 94 for short) is a module of the adaptive UI system 10 that is embedded in the mobile application 18. APP-SDK 94 may, for example, interface with the user-interface module 95 of mobile application 18. APP-SDK 94 typically interacts with OS-SDK 92 to modify the user-interface of mobile application 18 per instructions from mobile interface module 91.

It is appreciated that a plurality of mobile applications 18 may be installed in mobile device 14, each with its APP-SDK 94. Mobile interface module 91 may therefore be communicatively coupled with a plurality of APP-SDKs 94. While FIG. 8 shows only one mobile applications 18, user-interface module 95, and APP-SDK 94, is may be understood that mobile device 14 may include a plurality of these software programs or modules and therefore mobile interface module 91 may communicate with the plurality of APP-SDKs 94, and/or with the APP-SDK 94 associated with the currently executing mobile application 18.

It is appreciated that the UI modification software program 12, and particularly OS-SDK 92 and/or APP-SDKs 94, may divert at least part of the user-interface of the mobile application 18 to input and/or output devices of the car such as dashboard display, entertainment system display, steering-wheel controls, etc. The attention-adapted user-interface may therefore refer, for example, to a modified display presented on the dashboard screen.

UI modification software program 12 may also include assessment interface module 96 typically configured to interface with attention assessment software 13. Assessment interface module 96 may collect from attention assessment software 13 the driver's current attention status, including attention consumed by ambient conditions, and/or available attention.

UI modification software program 12 may also include assessment analysis module 97 typically communicatively coupled with assessment interface module 96 and with mobile interface module 91. Assessment analysis module 97 may analyze the driver's available attention received from attention assessment software 13 and the attention requirements of currently operating mobile application 18 to determine the adequate operation of mobile application 18.

To determine the adequate operation of the currently operating mobile application 18 assessment analysis module 97 may consult database 98. Database 98 may include a list, or database, of UI modes 99, a list, or database, of archetypal UI formats 100, and a list, or database, of application UIs 101.

UI modification software program 12 may also include attention-adaptive user-interface (AAUI) module 102 communicatively coupled to mobile interface module 91, to assessment analysis module 97, and to a collection 103 of UI modules.

UI modules 103 may include a speech recognition module 104, a text-to-speech module 105, steering wheel keypads module 106, touch screen module 107, etc.

Responsive to the operation of the mobile application 18, as presented by its UI 95, via APP-SDK 94 and/or OS-SDK 92, and via mobile interface module 91, AAUI module 102 employs the output of assessment analysis module 97 to operate the UI modules 103 to interact with the user 34. Thus AAUI module 102 modifies the user-interface of the mobile application 18 and adapts it to the driver's available attention as determined by assessment analysis module 97.

UI modification software program 12 may also include car interface module 108, enabling UI modules 103 to access various user input/output (I/O) devices such as the car entertainment system 15, UIDs 33, I/O devices of the mobile device (e.g., smartphone) 14, etc.

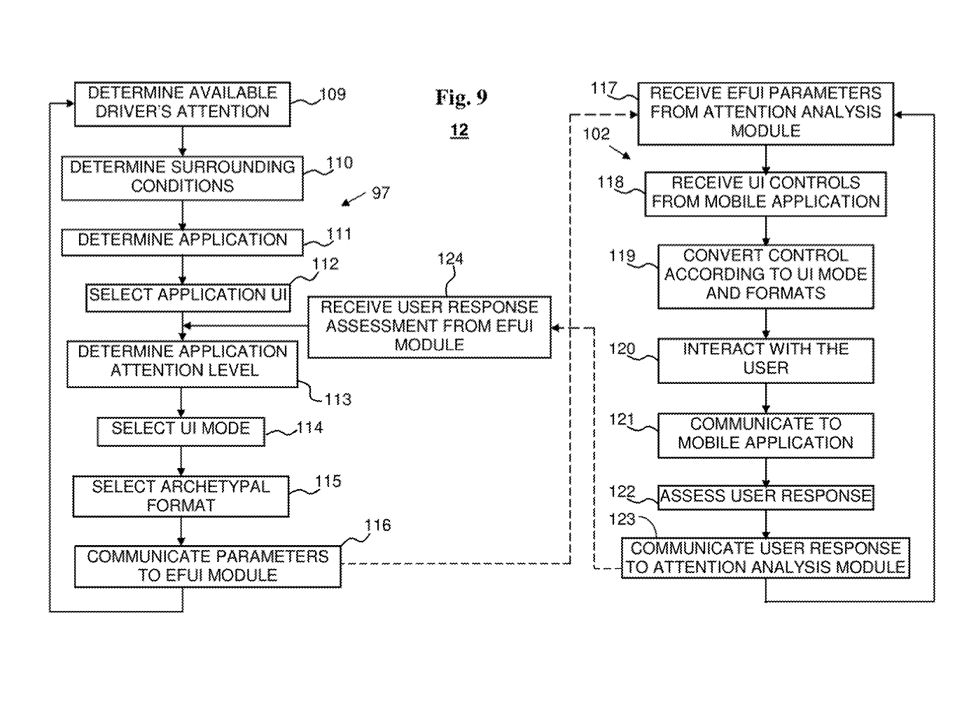

Reference is now made to FIG. 9, which is a simplified flow-chart of UI modification software program 12, according to one exemplary embodiment.

As an option, the flow-chart of UI modification software program 12 of FIG. 9 may be viewed in the context of the details of the previous Figures. Of course, however, the flow-chart of UI modification software program 12 of FIG. 9 may be viewed in the context of any desired environment. Further, the aforementioned definitions may equally apply to the description below.

As shown in FIG. 9, the flow-chart describes components of assessment analysis module 97 and AAUI module 102 of UI modification software program 12, which operate interactively.

The operation of UI modification software program 12 may start with steps 109 and 110, by assessment analysis module 97 receiving from driver attention assessment system 31 (or assessment software program 13), via assessment interface module 96, data such as driver attention data and surrounding conditions data (respectively).

Assessment analysis module 97 may proceed with step 111 to receive from mobile device 14, particularly from APP-SDK 94 or OS-SDK 92 via mobile interface module 91 data regarding the mobile application 18 currently executing in mobile device 14. Based on this data assessment analysis module 97 may proceed to step 112 to select application UI data from application UIs database 101. Based on this information assessment analysis module 97 may proceed to step 113 to determine the attention requirements of the mobile application 18.

Based on the information collected assessment analysis module 97 may proceed to step 114 to select a UI mode from the UI modes database 99. The term UI mode may refer to a particular configuration of user-interface media, or means. It is appreciated that an optional UI mode is not to enable user interaction with mobile application 18. In this scenario assessment analysis module 97 may determine, for example, that mobile application 18 requires attention more than the driver's available attention and therefore no user interaction with the currently running mobile application 18 should be allowed.

If, for example, the attention requirements of the mobile application 18 are less than the driver's available attention assessment analysis module 97 may select an appropriate UI mode. An appropriate UI mode is a mode for which the attention requirements of the mobile application 18 are less than the driver's available attention. As described above, if no UI mode consume driver's attention which is less than the driver's available attention then assessment analysis module 97 may disable the mobile application 18, or delay the operation of mobile application 18, or disable particular features or functions of mobile application 18, until the driver's available attention reaches the level required by the mobile application 18.

Based on the information collected assessment analysis module 97 may proceed to step 115 to select an archetypal format from the archetypal formats database 100.

Assessment analysis module 97 may proceed to step 116 to communicate the data collected and/or selected to the AAUI module 102.

It is appreciated that steps 109 to 116 may repeat continuously as the ambient conditions may change, as well as the surrounding conditions, thus changing the driver's attention consumed by the ambient conditions and consequently the driver's available attention. Obviously, the mobile application 18 may also change. Therefore, assessment analysis module 97 may communicate data updates to AAUI module 102 repeatedly, as such data updates become available.

The operation of UI modification software program 12 may then continue with step 117 of AAUI module 102, by receiving the data collected and/or selected assessment analysis module 97.

AAUI module 102 may then proceed to step 118 to receive UI controls from mobile application 18, typically via APP-SDK 94 or OS-SDK 92 and via mobile interface module 91. The term ‘UI controls’ refers to I/O instructions of mobile application 18 for interactions with the user.

AAUI module 102 may then proceed to step 119 to convert the UI controls into different mode of user interface according to the data provided by assessment analysis module 97. Particularly, AAUI module 102 may convert the UI controls according to the UI mode and archetypal formats selected by the assessment analysis module 97 and also according to the surrounding conditions. In step 119 AAUI module 102 generates AAUI controls, which are adapted, on one hand, to the particular UI controls of the particular mobile application 18 currently operating in mobile device (Smartphone) 14, and, on the other hand, to the UI mode and archetypal formats selected by the assessment analysis module 97 and to the surrounding conditions, as detected by the attention assessment system 31.

The term ‘surrounding conditions’ may refer to conditions such as noise and light which may affect features such as volume level, brightness, etc. AAUI module 102 may decide, for example, to delay a particular action such as presenting a verbal menu, until, for example, the noise level reduces.

AAUI module 102 may then proceed to step 120 to use the AAUI controls to interact with the user, and then, in step 121, to communicate the user's response, to the mobile application 18. AAUI module 102 may communicate the user's response to the mobile application 18 via mobile interface module 91 and APP-SDK 94 or OS-SDK 92.

AAUI module 102 may then proceed to step 122 to assess the user's response in terms such as response time ns errors. Measuring such parameters may indicate lack of sufficient driver's attention. For example, a slow response or repeated errors. An error may be indicated in the form of operating a wrong UIDs 33, making an unavailable selection (e.g., wrong key), making a selection and then returning to a previous menu, requesting repetition of the last menu, etc. AAUI module 102 may then proceed to step 123 to communicate the assessment of the driver's response to the assessment interface module 96.

It is appreciated that step 117 to 123 (optionally including step 124) may repeat according to the UI requirements of the mobile application and the UI selections by the user.

Returning to the flow-chart of assessment analysis module 97, in step 124, the assessment analysis module 97 receives the driver's response assessment and in step 113 the assessment analysis module 97 includes the driver's response assessment in the algorithm for calculating and determining the attention level required by the mobile application 18. Assessment analysis module 97 may then select a different UI mode, and/or a different archetypal format, and communicate such selections to the AAUI module 102.

It is therefore appreciated that UI modification software program 12, and particularly assessment analysis module 97 and AAUI module 102, process continuously, and/or repeatedly, and/or in real-time, the modification and/or adaptation of the user-interface of the mobile application 18 according to the changing ambient conditions, surrounding conditions, and driver's conditions, as measured in real-time.

Adaptive UI system 10 therefore enables a user to perform operations such as:
Define a plurality of ambient conditions.
Associate a set of measurable ambient values for each of the ambient conditions.
Define at least one rule for measuring at least one of the ambient conditions to form a measured ambient value
Define at least one rule for computing a user attention requirement value based on the measurable ambient values.

Using such rules adaptive UI system 10 therefore may measuring at least one of the ambient conditions to form a measured ambient value, compute a user attention requirement value based on the measurable ambient values, and adapt the user-interface to the changing driver's attention available for the application.

For example, the following describes a possible scenario where adaptive UI system 10 may adapt the user-interface to the changing driver's attention available for the application.

The user uses a chat program on her mobile phone to communicate with a group of friends. The user then enters the car and starts driving. The adaptive UI system 10 detects the condition and changes the UI so it can be used while driving, e.g. with minimal GUI augmented by a voice based interface.

The user continues driving increasing her speed thus demanding higher driver's attention, and leaving less available attention. The adaptive UI system 10 adapts the UI by reducing the speed of the voice output.

The user continues driving and arrives at the proximity of a school when students are going home. The adaptive UI system 10 detects the location and blocks the chat functions altogether to allow driver completely focus on the driving. When the car leaves the school zone, the adaptive UI system 10 returns the UI to a limited mode suitable for use when driving.

Therefore, combining the functions of attention assessment software program 13 and UI modification software program 12, adaptive UI system 10 may execute the following actions:
Measure effects consuming attention of a user (e.g., driver) operating a first device (e.g., a car) and/or a first software program (e.g., a mobile application).
Assess attention requirement from the user by the measured effects;
Assess availability of the user's attention required to operate a second device (e.g., a smartphone) and/or a second software program (e.g., a mobile application), where the second device and/or software program includes a user-interface.
Modify the user-interface according to the available attention.
Measuring the quality of the user's interaction with the second device and/or second software program and form a user response level.
Further adapting the user-interface of the second device and/or second software program according to the level of user response.

For example, the user-interface of the second device and/or second software program may be further adapted to improve the level of the user response with respect to a predefined level or threshold.

The adaptive UI system 10 may further associate effects with sensory types (or faculty) so that a particular effect affects the attention associated with one or more sensory types. The actions of modifying the user-interface may then additionally use a second sensory type that is different from the first sensory type.

Similarly, the action of assessing for the user available attention may also detect a diminished sensory type of the user, and then the action of modifying the user-interface may use a second sensory type that is different from the diminished sensory type.

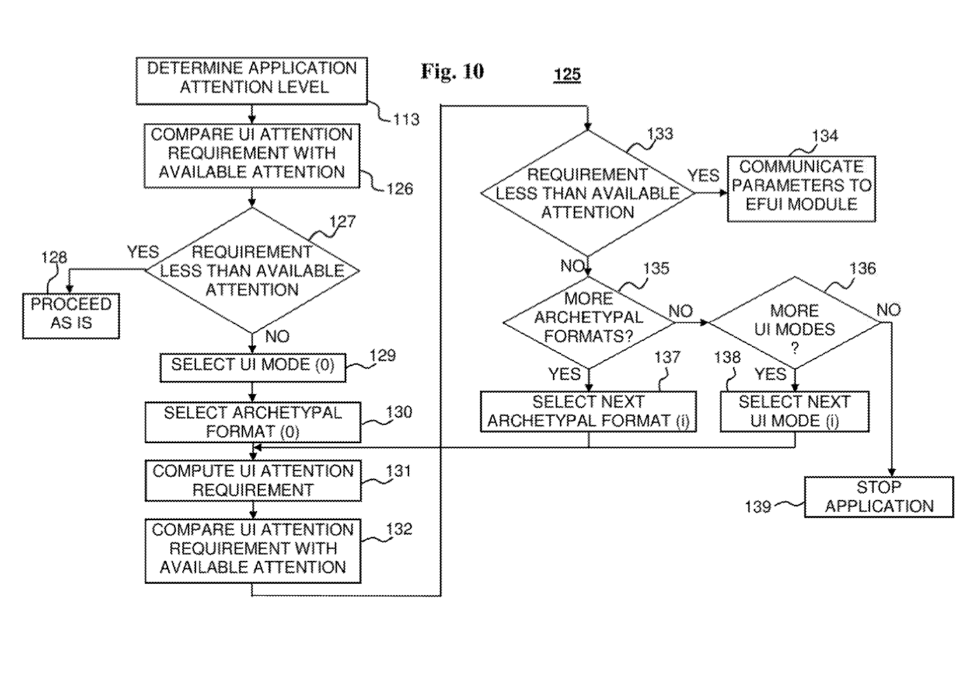

Reference is now made to FIG. 10, which is a simplified flow-chart of UI selection process 125, according to one exemplary embodiment.

As an option, the flow-chart of UI selection process 125 of FIG. 10 may be viewed in the context of the details of the previous Figures. Of course, however, flow-chart of UI selection process 125 of FIG. 10 may be viewed in the context of any desired environment. Further, the aforementioned definitions may equally apply to the description below. Particularly, UI selection process 125 may be understood as a more detailed exemplary embodiment of steps 113 to 116 of FIG. 9.

As shown in FIG. 10, UI selection process 125 may start with step 113 by determining the attention requirement of the mobile application 18 currently executed by, for example, smartphone 14. UI selection process 125 may then compare the required attention with the available attention (step 126) and if the required attention is less than the available attention (step 127) proceed with the application as is (step 128).

If the available attention is insufficient to accommodate the native UI of the mobile application 18, UI selection process 125 may proceed to steps 129 and 130 to select a first UI mode and a first archetypal format. UI selection process 125 may proceed to steps 131 and 132 to compute the UI attention required by the current selection of UI mode and archetypal format, and to compare it with the available selection.

For example, there may be five UI modes and six archetypal formats creating 30 possible combinations of UI modes and archetypal formats. Each of this combinations may be given a value between 1 and 100, where the value represents a relative attention load (requirement). The available attention may also be measured, or normalized to, a value between 1 and 100. The attention required by a particular mobile application modified using a particular combination of UI mode and archetypal format may be compared with the driver's available attention as currently assessed.

It is appreciated that a UI mode, and/or an archetypal format, may have a different value for different driver, or in a different situation.

If the available attention is sufficient (step 133) to accommodate the UI of the mobile application 18 as adapted using the current selection of UI mode and archetypal format, UI selection process 125 may proceed to step 134 to communicate these UI parameters (e.g., UI mode and archetypal format) to the AAUI (or EFUI) module (e.g., process 102).

If the available attention is insufficient to accommodate the mobile application 18 UI as adapted using the current selection of UI mode and archetypal format, UI selection process 125 may proceed to select another archetypal format. If no archetypal format combined with a particular UI mode provides attention requirement below the driver's available attention (step 135) UI selection process 125 may proceed to step 136 to select another UI mode.

If a next combination of UI mode and archetypal format is selected (steps 137 and/or 138) UI selection process 125 may return to steps 131 and 132 to check that attention requirement of the adapted UI compatible with the driver's available attention. If no combination of UI mode and archetypal format can provide the require attention level the UI selection process 125 may stop the application (step 139).

In this respect, adaptive UI system 10 may assess the attention requirement from the user by the modified user-interface to form UI attention requirement, and then modify the user-interface to achieve UI attention requirement adaptive to (within, below) the available attention level.

Therefore, when modifying the user-interface according to the available attention and/or when adapting the user-interface according to the level of user response, adaptive UI system 10 may select a user-interface mode adapted to the selected and/or a user-interface format (typically associated with the selected user-interface mode). Adaptive UI system 10 may further select an output device configured to interact with the user, typically associated with the selected user-interface mode, and/or an input device configured to interact with the user, typically associated with the selected user-interface format.

In that regard, adaptive UI system 10 may modify the user-interface according to the available attention and/or adapt the user-interface according to the level of user response by using a peripheral user-output device other than a native user-output device of the second device and/or software program. Adaptive UI system 10 may further emulate of a user entry using a peripheral user-input device other than a native user-input device of the at least one of second device and a second software program.

Such emulation may include conversion of a user-generated input into a different modality. For example, conversion of user speech input into text input or alphanumeric input. Such emulation may include computer-generated input replacing a user-generated input.

For example, adaptive UI system 10 may determine a forward-looking (future) attention assessment that does not allow any further attention requiring task. For example, adaptive UI system 10 may determine that the driver approaches a sharp turn. The adaptive UI system 10 may also determine that the river's relaxation period following the sharp turn is short. Consequently, the adaptive UI system 10 may determine that all interruptions within the next 15 seconds should be blocked. Adaptive UI system 10 may then recognize a telephone call received by the mobile device (smartphone). Adaptive UI system 10 may inhibit the ringing and yet accept the call and generate, or emulate, a user input requesting the caller to hold on for few seconds. When the blocking period (e.g., 15 seconds, or completion of the turn) completes adaptive UI system 10 may connect the driver with the caller.

In this respect, the adaptive UI system 10 may also adapting a user-interface by delaying an output to the user, and/or by eliminating an option and/or a function such as an option and/or a function offered by a menu of a mobile application. The adaptive UI system 10 may also splitting a menu, and/or reduce the number of options in a menu. For example, a visual menu may include more options than a vocal (verbally presented) menu, A long vocal (speech-based) menu my load the user's attention more than a short menu. On the other hand, splitting a (visual) menu into two (or more) verbal menus creates a longer interaction with the user. Appropriate selection and ordering of the options in a split menu (into a primary and one or more secondary menus) may present the user with less options at a time while eliminating the need to make use of several menus.

It is appreciated that adaptive UI system 10 may enable a user to associate one or more effect with one or more sensory types. UI system 10 may then detect a particular effect, and assess a particular attention load created by that effect and associated with a particular sensory type. Thereafter UI system 10 may modify the user-interface by selecting an appropriate UI mode associated with a particular peripheral user-output and/or user-input device adapted to a second sensory type being different than the first sensory type.

Similarly, modifying the user-interface may also include emulation of a user entry using a peripheral user-input device adapted to a second sensory type being different than the first sensory type.

Alternatively, modifying the user-interface may also include detecting for the user at least one diminished sensory type, and modifying the user-interface by using a peripheral user-output device adapted to a second sensory type being different from the first sensory type.

Similarly, adaptive UI system 10 may also emulate of a user entry using a peripheral user-input device adapted to a second sensory type being different from the first sensory type.

Considering personalization, adaptive UI system 10 may enable a user to define one or more driver's behavioral parameters and then associate a set of measurable behavioral values for each behavioral parameter. Adaptive UI system 10 may then measure such one or more driver's behavioral parameters creating respective measured behavioral values. Thereafter, adaptive UI system 10 may adapt the user-interface of a mobile application (or similar) according to the assessment of user available attention and the measured behavioral value.

As disclosed above, adaptive UI system 10 may adapt the user-interface of a mobile application to the available attention of a driver by performing the following actions:

Enable a user to define a plurality of ambient conditions and to associate a set of measurable ambient values for each of said ambient conditions.

Enable a user to provide at least one rule for computing a user attention requirement value based on the measurable ambient values.

Measure the ambient conditions to form respective measured ambient values, and compute user attention requirement using at least one measured ambient value and at least one respective rule.

Select an output device, and/or an input device, and a corresponding user-interface mode employing a particular interaction medium such as sound, speech output, speech input, visual output, dashboard display, tactile input, touch sensitive screen, steering-wheel control, etc.

The UI mode may be selected according to the available attention, the ambient condition, the behavioral value, the available attention, or lack of available attention, or lack of capacity, of a particular sensory type (faculty), etc.

The output device, input device, and user-interface format may include or provide or support various selection means such as an up-down selection, a left-right selection, a D-pad selection, an eight-way selection, a yes-no selection, a numeral selection, a cued selection, etc. The UI format may be selected according to the available attention, the ambient condition, the behavioral value, and/or a sensory type as described above. For example, if the UI mode supports speech the format may vary the speech rate, and/or speech volume.

In this respect, adaptive UI system 10 may determine that a driver is suffering a hearing loss, or that the driver's surrounding is noisy, and therefore convert a vocal user interface with a different UI mode. For example, the adaptive UI system 10 may automatically increase the vocal output (volume) and replace the vocal input with a tactile (manual) input (e.g., menu selection using key entry).

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A method for adapting user interface, the method comprising:
measuring effects consuming attention of a user operating at least one of a first device and a first software program;
assessing attention requirement from said user by said effects;
assessing for said user available attention for operating at least one of a second device and a second software program, wherein said at least one of a second device and a second software program comprises a user-interface;
modifying said user-interface according to said available attention;
measuring user interaction with said at least one of second device and a second software program to form level of user response; and
adapting said user-interface according to said level of user response.

2. The method of claim 1 wherein said step of modifying said user-interface additionally comprises:
associating at least one of said effects with at least one first sensory type; and
wherein said step of modifying said user-interface additionally comprises:
using a second sensory type being different than said first sensory type.

3. The method of claim 1 wherein said step of assessing for said user available attention comprises:
detecting for said user at least one diminished sensory type; and
wherein said step of modifying said user-interface comprises:
using a second sensory type different than said diminished sensory type.

4. The method of claim 1 wherein said step of adapting said user-interface additionally comprises:
adapting said user-interface to improve said level of user response with respect to a predefined level.

5. The method of claim 1 wherein at least one of:
said modifying said user-interface according to said available attention; and
said step of adapting said user-interface according to said level of user response;
additionally comprises selecting at least one of:
output device configured to interact with said user;
input device configured to interact with said user;
user-interface mode; and
user-interface format.

6. The method of claim 1 wherein at least one of:
said modifying said user-interface according to said available attention; and
said step of adapting said user-interface according to said level of user response;
additionally comprises at least one of:
using a peripheral user-output device other than a native user-output device of said at least one of second device and a second software program; and
emulation of a user entry using a peripheral user-input device other than a native user-input device of said at least one of second device and a second software program.

7. The method of claim 1 additionally comprising:
assessing attention requirement from said user by said modified user-interface to form UI attention requirement; and
modifying said user-interface to achieve UI attention requirement below said available attention.

8. The method of claim 1 wherein said step of adapting said user-interface comprises at least one of: delaying an output to said user, eliminating an at least one of an option and a function, splitting a menu, and reducing number of options in a menu.

9. The method of claim 1 additionally comprising at least one of:
said step of modifying said user-interface additionally comprising associating at least one of said effects with at least one first sensory type; and said step of modifying said user-interface additionally comprising at least one of:
using a peripheral user-output device adapted to a second sensory type being different than said first sensory type; and
emulation of a user entry using a peripheral user-input device adapted to a second sensory type being different than said first sensory type; and
detecting for said user at least one diminished sensory type; and wherein said step of modifying said user-interface comprises:
using a peripheral user-output device adapted to a second sensory type being different than said first sensory type; and
emulation of a user entry using a peripheral user-input device adapted to a second sensory type being different than said first sensory type.

10. The method of claim 1 additionally comprising:
defining at least one driver's behavioral parameter;
associating a set of measurable behavioral values for said at least one driver's behavioral parameter;
measuring said at least one driver's behavioral parameter to form a measured behavioral value; and
adapting said user-interface according to said assessment of user available attention and said measured behavioral value.

11. The method of claim 1 wherein said user available attention is assessed by a method comprising:
defining a plurality of ambient conditions;
associating a set of measurable ambient values for each of said ambient conditions;
providing at least one rule for computing a user attention requirement value based on at least one of said measurable ambient values;
measuring at least one of said ambient conditions to form a measured ambient value; and
computing user attention requirement comprising at least one of said measured ambient values, using said at least one rule.

12. The method of claim 5 wherein at least one of said output device, input device, and user-interface mode comprises at least one of mode selected from a group of mode comprising: sound, speech output, speech input, visual output, dashboard display, tactile input, touch sensitive screen, and steering-wheel control; and
wherein said mode is selected according to at least one of: available attention, ambient condition and behavioral value.

13. The method of claim 5 wherein at least one of said output device, input device, and user-interface format comprises at least one format of a group of formats comprising: up-down selection, left-right selection, D-pad selection, eight-way selection, yes-no selection, numeral selection and cued selection; and
wherein said format is selected according to at least one of: available attention, ambient condition and behavioral value.

14. The method of claim 5 wherein said mode comprises speech and wherein said format comprises at least one of varying rate of said speech, and varying volume of said speech.

15. A system for adapting user interface, the system comprising:
an attention assessment module configured to:
measure effects consuming attention of a user operating at least one of a first device and a first software program;
assess attention requirement from said user by said effects;
assess for said user available attention for operating at least one of a second device and a second software program, wherein said at least one of a second device and a second software program comprises a user-interface; and
a user-interface adapting module configured to:
modify said user-interface according to said available attention;
measure user interaction with said at least one of second device and a second software program to form level of user response; and
adapt said user-interface according to said level of user response.

16. The system according to claim 15 wherein said user-interface adapting module is additionally configured to:
enable a user to associate at least one of said effects with at least one first sensory type; and
modifying said user-interface using a second sensory type being different than said first sensory type.

17. The system according to claim 15 wherein said attention assessment module is additionally configured to detect, for said user, at least one diminished sensory type; and
wherein user-interface adapting module is additionally configured to use a second sensory type different than said diminished sensory type.

18. The system according to claim 15 wherein said user-interface adapting module is additionally configured to adapt said user-interface to improve said level of user response with respect to a predefined level.

19. The system according to claim 15 wherein said user-interface adapting module is additionally configured to select at least one of:
output device configured to interact with said user;
input device configured to interact with said user;
user-interface mode; and
user-interface format.

20. The system according to claim 15 wherein said user-interface adapting module is additionally configured to:
use a peripheral user-output device other than a native user-output device of said at least one of second device and a second software program; and
emulate of a user entry using a peripheral user-input device other than a native user-input device of said at least one of second device and a second software program.

21. The system according to claim 15 wherein
said attention assessment module is additionally configured to assess attention requirement from said user by said modified user-interface to form UI attention requirement; and
wherein said user-interface adapting module is additionally configured to modify said user-interface to achieve UI attention requirement below said available attention.

22. The system according to claim 15 wherein said user-interface adapting module is additionally configured to perform at least one of: delay an output to said user, eliminate an at least one of an option and a function, split a menu, and reduce number of options in a menu.

23. The system according to claim 15 wherein
said attention assessment module is additionally configured to:
enable a user to associate at least one of said effects with at least one first sensory type; and
detect, for said user, at least one diminished sensory type; and
said user-interface adapting module is additionally configured to perform at least one of:
use a peripheral user-output device adapted to a second sensory type being different than said first sensory type; and
emulate a user entry using a peripheral user-input device adapted to a second sensory type being different than said first sensory type; and

24. The system according to claim 15 wherein
said attention assessment module is additionally configured to:
enable a user to define at least one driver's behavioral parameter;
enable a user to associate a set of measurable behavioral values for said at least one driver's behavioral parameter; and
measure said at least one driver's behavioral parameter to form a measured behavioral value; and
wherein said user-interface adapting module is additionally configured to adapt said user-interface according to said assessment of user available attention and said measured behavioral value.

25. The system according to claim 15 wherein said attention assessment module is configured to:
enable a user to define a plurality of ambient conditions;
enable a user to associate a set of measurable ambient values for each of said ambient conditions;
enable a user to provide at least one rule for computing a user attention requirement value based on at least one of said measurable ambient values;
measure at least one of said ambient conditions to form a measured ambient value; and
compute user attention requirement according to said at least one measured ambient values, and using said at least one rule.

26. The system according to claim 19 wherein at least one of said output device, input device, and user-interface mode comprises at least one of mode selected from a group of mode comprising: sound, speech output, speech input, visual output, dashboard display, tactile input, touch sensitive screen, and steering-wheel control; and
wherein said mode is selected according to at least one of: available attention, ambient condition and behavioral value.

27. The system according to claim 19 wherein at least one of said output device, input device, and user-interface format comprises at least one format of a group of formats comprising: up-down selection, left-right selection, D-pad selection, eight-way selection, yes-no selection, numeral selection and cued selection; and
wherein said format is selected according to at least one of: available attention, ambient condition and behavioral value.

28. The system according to claim 19 wherein said mode comprises speech and wherein said format comprises at least one of varying rate of said speech, and varying volume of said speech.

29. A non-transitory computer readable medium include instructions that, when executed by at least one processor, cause the at least one processor to perform operations comprising:
measuring effects consuming attention of a user operating at least one of a first device and a first software program;
assessing attention requirement from said user by said effects;
assessing for said user available attention for operating at least one of a second device and a second software program, wherein said at least one of a second device and a second software program comprises a user-interface;
modifying said user-interface according to said available attention;
measuring user interaction with said at least one of second device and a second software program to form level of user response; and
adapting said user-interface according to said level of user response.

30. The instructions according to claim 29 wherein said step of modifying said user-interface additionally comprises:
associating at least one of said effects with at least one first sensory type; and
wherein said step of modifying said user-interface additionally comprises:
using a second sensory type being different than said first sensory type.

31. The instructions according to claim 29 wherein said step of assessing for said user available attention comprises:
detecting for said user at least one diminished sensory type; and
wherein said step of modifying said user-interface comprises:
using a second sensory type different than said diminished sensory type.

32. The instructions according to claim 29 wherein said step of adapting said user-interface additionally comprises:
adapting said user-interface to improve said level of user response with respect to a predefined level.

33. The instructions according to claim 29 wherein at least one of:
said modifying said user-interface according to said available attention; and
said step of adapting said user-interface according to said level of user response;
additionally comprises selecting at least one of:
output device configured to interact with said user;
input device configured to interact with said user;
user-interface mode; and
user-interface format.

34. The instructions according to claim 29 wherein at least one of:
said modifying said user-interface according to said available attention; and
said step of adapting said user-interface according to said level of user response;
additionally comprises at least one of:
using a peripheral user-output device other than a native user-output device of said at least one of second device and a second software program; and
emulation of a user entry using a peripheral user-input device other than a native user-input device of said at least one of second device and a second software program.

35. The instructions according to claim 29 additionally comprising:
assessing attention requirement from said user by said modified user-interface to form UI attention requirement; and
modifying said user-interface to achieve UI attention requirement below said available attention.

36. The instructions according to claim 29 wherein said step of adapting said user-interface comprises at least one of: delaying an output to said user, eliminating an at least one of an option and a function, splitting a menu, and reducing number of options in a menu.

37. The instructions according to claim 29 additionally comprise at least one of:
said step of modifying said user-interface additionally comprising associating at least one of said effects with at least one first sensory type; and said step of modifying said user-interface additionally comprising at least one of:
using a peripheral user-output device adapted to a second sensory type being different than said first sensory type; and
emulation of a user entry using a peripheral user-input device adapted to a second sensory type being different than said first sensory type; and
detecting for said user at least one diminished sensory type; and wherein said step of modifying said user-interface comprises:
using a peripheral user-output device adapted to a second sensory type being different than said first sensory type; and
emulation of a user entry using a peripheral user-input device adapted to a second sensory type being different than said first sensory type.

38. The instructions according to claim 29 additionally comprise:
defining at least one driver's behavioral parameter;
associating a set of measurable behavioral values for said at least one driver's behavioral parameter;
measuring said at least one driver's behavioral parameter to form a measured behavioral value; and
adapting said user-interface according to said assessment of user available attention and said measured behavioral value.

39. The instructions according to claim 29 wherein said user available attention is assessed by a method comprising:
defining a plurality of ambient conditions;
associating a set of measurable ambient values for each of said ambient conditions;
providing at least one rule for computing a user attention requirement value based on at least one of said measurable ambient values;
measuring at least one of said ambient conditions to form a measured ambient value; and
computing user attention requirement comprising at least one of said measured ambient values, using said at least one rule.

40. The instructions according to claim 39 wherein at least one of said output device, input device, and user-interface mode comprises at least one of mode selected from a group of mode comprising: sound, speech output, speech input, visual output, dashboard display, tactile input, touch sensitive screen, and steering-wheel control; and
wherein said mode is selected according to at least one of: available attention, ambient condition and behavioral value.

41. The instructions according to claim 39 wherein at least one of said output device, input device, and user-interface format comprises at least one format of a group of formats comprising: up-down selection, left-right selection, D-pad selection, eight-way selection, yes-no selection, numeral selection and cued selection; and
wherein said format is selected according to at least one of: available attention, ambient condition and behavioral value.

42. The instructions according to claim 39 wherein said mode comprises speech and wherein said format comprises at least one of varying rate of said speech, and varying volume of said speech.
